(19) United States
(12) Patent Application Publication
(10) Pub. No.: US 2013/0201553 A1
(43) Pub. Date: Aug. 8, 2013

(54) HIGH CAPACITY MICROSCOPE SLIDE INCUBATION SYSTEM AND MEETHOD

(71) Applicant: SciGene Corporation, Sunnyvale, CA (US)

(72) Inventors: Stanchfield James, Half Moon Bay, CA (US); Rajiv Raja, San Ramon, CA (US); Kevin Heyes, Milpitas, CA (US)

(73) Assignee: SCIGENE CORPORATION, Sunnyvale, CA (US)

(21) Appl. No.: 13/775,901

(22) Filed: Feb. 25, 2013

Related U.S. Application Data
(63) Continuation of application No. 12/365,374, filed on Feb. 4, 2009.
(60) Provisional application No. 61/026,106, filed on Feb. 4, 2008.

(51) Int. Cl. G02B 21/34

(52) U.S. Cl. CPC G02B 21/34
USPC 359/398

(57) ABSTRACT

A microscope slide module for processing samples captured in gasketed compartments of slide assemblies which include gasket slides. The microscope slide module includes a baseplate having a number of recesses for holding the gasket slides in fixed position, a coverplate which attaches to the baseplate, such that slide assemblies including gasket slides are captured and slightly compressed between the baseplate and the coverplate. Fasteners attach the coverplate to the baseplate, and the baseplate and coverplate each include apertures which align with the gasketed compartments of the gasket slides. Also disclosed are a system and a method for processing laboratory samples.

The following is a non-provisional patent application which claims priority to provisional application 61/026,106 filed Feb. 4, 2008 by the same inventors.

### TECHNICAL FIELD

The present invention relates generally to equipment for processing of laboratory specimens and more particularly to equipment for the incubation of materials at elevated temperatures.

### BACKGROUND ART

Microscope slides that have a high density of known DNA, proteins or other biological samples bound at discrete positions are widely used in research and increasingly used in diagnostic laboratories for performing simultaneous analysis of many genes. Biological samples to be analyzed are typically manually pipetted onto a single microscope slide which is then sealed using a standard glass coverslip. The coverslipped sample is then placed into an air-tight two-piece metal holder (e.g. see hybridization cassettes at http://arrayit.com) and submerged into a waterbath or oven at the specified incubation temperature.

A superior alternative method that allows mixing of the sample during incubation is to create a chamber for the sample by using an intervening gasket and second cover glass leaving an air bubble trapped inside the three-component sample compartment that is formed (e.g. Agilent SureHyb System at http://www.chem.agilent.com/scripts/pds.asp?1Page=11373 and U.S. Pat. No. 7,247,499). The sealed assembly is then placed in a holder that presses the components together to seal them. To effect mixing, the holder with the formed sample compartment containing the bubble is rotated inside an oven at the specified incubation temperature so that the bubble agitates the sample by moving within the compartment. (see SciGene at http://www.scigene.com/products/777mo.html).

Existing microscope slide sample holders for rotational bubble mixing are designed for handling individual slides and require that the samples by introduced manually. However, the widening use of microscope slide technologies in both research and diagnostic laboratories has led to increasing numbers of samples being processed in parallel. Consequently, the existing single slide holder designs require repetitive effort during assembly and handling when processing multiple samples. Further, the existing holder designs are not compatible with automated liquid handling system precluding the possibility of automating the loading of samples.

### DISCLOSURE OF INVENTION

Accordingly, it is an advantage of the present invention that it presents a system in which one or more sealed microscope slides can be held in a module that has a standard microplate footprint.

Another advantage of the present invention is that it presents a system in which multiple microscope slides can be processed without the necessity of handling slides individually when assembling and disassembling the module.

A further advantage is that the present invention can be part of a compact system that is usable in small clinics as well as large laboratories.

Another advantage is that the microscope slide modules of the present invention are preferably configured with apertures in the baseplates and coverplates so the slide assemblies can be visually inspected, and the barcodes or other labels are visible.

An additional advantage is that the microscope slide modules of the present invention can be configured for easy insertion into a rotating oven by which incubation of materials can be done in a highly regulated isothermal environment.

Another advantage of the present invention is that apertures in base- and cover plates make it possible for air flow to quickly heat up the enclosed chamber to the desired temperature without having to heat up a large mass of surrounding metal.

A further advantage of the microscope slide modules of the present invention is that it preferably can hold up to 4 slide assemblies having 32 or more gasketed compartments, and can be easily sealed with one to four fasteners.

Yet another advantage of the present invention is that it provides a system that is compatible with automated sample handling equipment that allows for automated loading of samples under computer control to multiple microscope slides with the ability to conveniently seal the entire set.

A further advantage of the present invention is that it provides a system that improves the reliability of the loading process and simplifies handling of the microscope slides during subsequent mixing and incubation steps.

A yet further advantage of the present invention is that it provides finger recesses for easy insertion and removal of slides.

Briefly, one preferred embodiment of the present invention is a microscope slide module for processing samples captured in gasketed compartments of slide assemblies which include gasket slides. The microscope slide module includes a baseplate having a number of recesses for holding the gasket slides in fixed position, a coverplate which attaches to the baseplate, such that slide assemblies including gasket slides are captured and slightly compressed between the baseplate and the coverplate. Fasteners attach the coverplate to the baseplate, and the baseplate and coverplate each include apertures which align with the gasketed compartments of the gasket slides. Also disclosed are a system and a method for processing laboratory samples.

These and other advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows an isometric view of a first embodiment of the high capacity microscope slide module of the present invention;

FIG. 2 shows an exploded isometric view of an embodiment of the high capacity microscope slide module of the present invention;

FIG. 3 shows a detail of a portion of FIG. 2 of an embodiment of the high capacity microscope slide module of the present invention;

FIG. 4 shows an exploded isometric view of a second embodiment of the high capacity microscope slide module of the present invention;

FIG. 5 shows an isometric view of the underside of the coverplate of a second embodiment of the high capacity microscope slide module of the present invention;

FIG. 6 shows an isometric view of the assembled module of a second embodiment of the high capacity microscope slide module of the present invention;

FIG. 7 shows an isometric view of a rotator holding high capacity microscope slide modules of the present invention;

FIG. 8 shows an isometric view of an oven holding a rotator filled with high capacity microscope slide modules of the present invention; and

FIG. 9 shows a flowchart of the major stages of a method of using the high capacity microscope slide modules and system of the present invention.

### BEST MODE FOR CARRYING OUT THE INVENTION

The present invention is a high capacity microscope slide module which will be designated in the following discussion and figures as module 10 and a system for incubating and processing laboratory materials utilizing the module, which will be designated in the following discussion and figures as processing system 100.

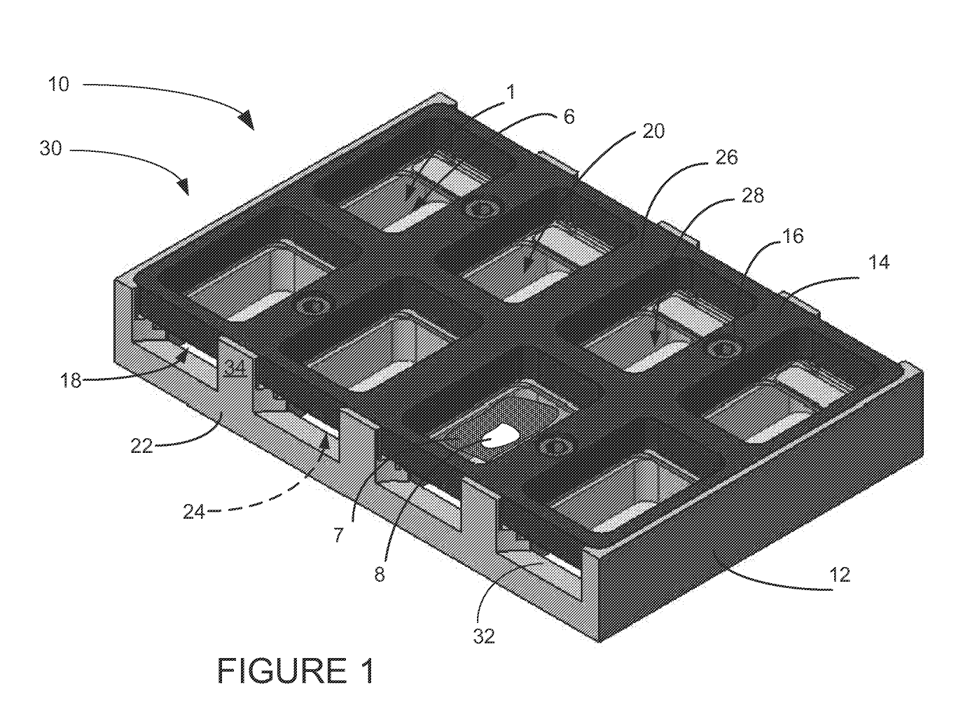

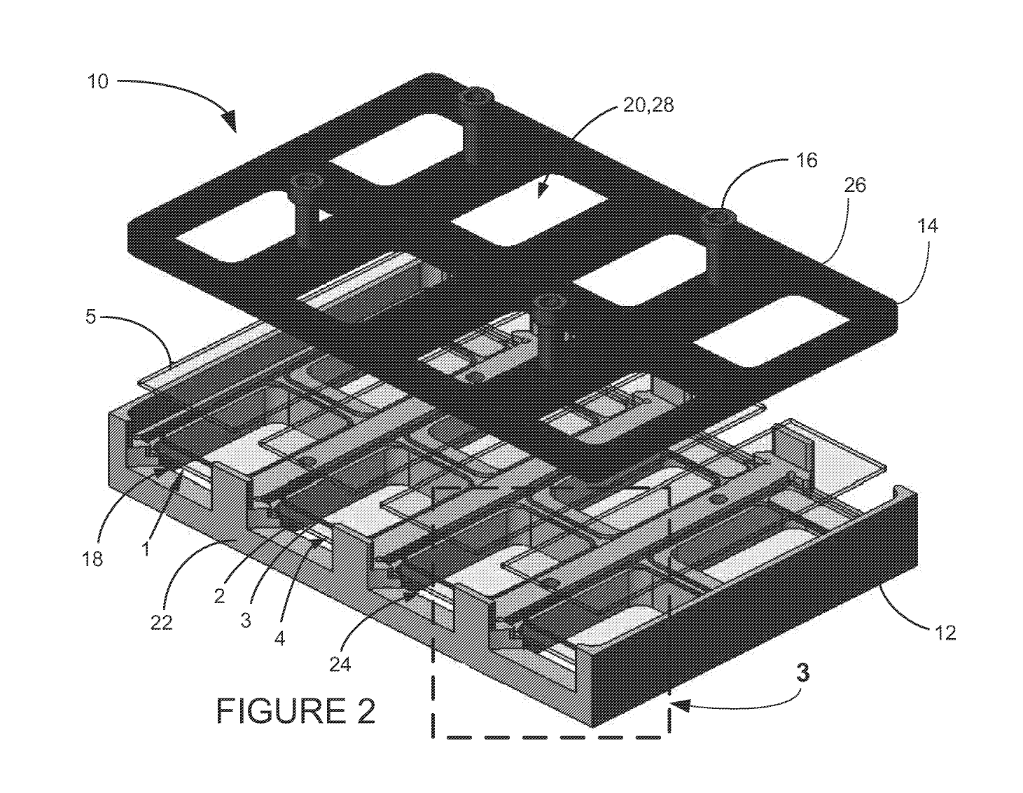

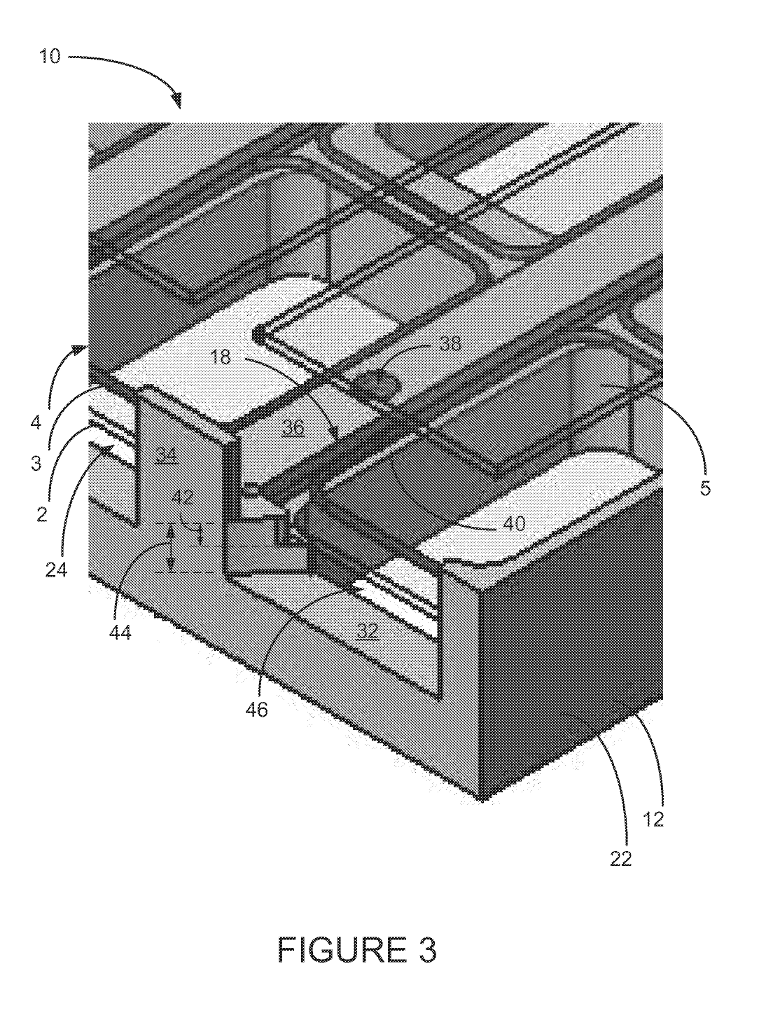

The module 10 is illustrated in FIGS. 1-3, of which FIG. 3 is an enlarged detail view of the area designated in FIG. 2. Referring generally to these figures, the module 10 includes a baseplate 12, a coverplate 14 and multiple fasteners 16, which are configured to capture and hold in fixed relation a number of assembled microscope slide/gasket slides, which will be referred to in the following discussion as slide assemblies 1.

As shown in FIG. 1, and in more detail in FIGS. 2 and 3, these slide assemblies 1 include a lower slide 2, and one or more gaskets 3, which together comprise a gasket slide 4, as well as an upper slide which will be referred to as a microscope slide 5. These gasket slides 4 are of a type such as are manufactured by Agilent (cat # G2534-60003) or similar devices that hold liquid samples within the confines of the gasket walls.

When the microscope slide 5 is placed onto the gasket slide 4, the gaskets 3 are captured between the lower slide 2 and the microscope slide 5. Thus, the upper surface of the lower slide 2, the walls of the gaskets 3, and the lower surface of the microscope slide 5 form air-and-liquid-tight gasketed compartments 6 into which samples of materials 7 are held. When the slide assembly 1 is completed, preferably an air bubble 8 is captured within the compartment 6, which will be used in the mixing process, as discussed below.

The present module 10 invention utilizes a base plate 12 of industry standard microplate footprint dimensions. Up to four of the gasket slides 4, each preferably having two gaskets 3, are placed in recesses 18 in the base plate 12. The base plate 12 with gasket slides 4 is then placed in position on the liquid handler (not shown) in preparation for dispensing the samples. Samples 7 are then dispensed onto the gasket slides 4 by an automated pipettor (not shown) such that the gasketed compartments 6 are not completely filled, so that an air bubble 8 will be formed when sealed. Microscope slides 5 are then manually placed on top of the gasket slides 4 to form the completed slide assemblies 1. In the final step, the cover plate 14 is placed over the sandwiched slide assemblies 1, and the fasteners 16 tightened to draw the coverplate 14 to the baseplate 12 to effect pressure on the slide assembly 1. The assembled module 10, including the completed slide assemblies 1 with gasketed samples 7, will be referred to as microscope slide module 30.

The gasketed samples 7 are then to be heated or subjected to other processing, so it is important that the surfaces of the slide assemblies 1 be open to heating convection. To this end, the baseplate 12 and coverplate 14 are configured with openings or apertures 20. The baseplate 12 thus includes a baseplate frame 22 which surrounds a number of baseplate apertures 24. In a similar manner, the coverplate 14 includes a coverplate frame 26 which surrounds a number of coverplate apertures 28. These baseplate apertures 24 and coverplate apertures 28 preferably align with the gasketed compartments 6 of the slide assemblies 1, so that heat is transferred to the gasketed sample materials 7 most efficiently.

It is also an advantage that the slide assemblies 1, which are captured inside the microscope slide modules 30, are open to visual inspection through the aligned apertures.

It is possible that other processing methods can also be applied to the gasketed samples while they are held in the module array. Since the apertures admit both heat and various wavelengths of radiations, such as light, it is possible that the present modules could be used to hold biological samples while they are exposed to laser scanning, UV exposure, spectrophotometry, etc. It is also possible that the slides used in the slide assemblies may not be made of glass, and may not even be transparent. The slides therefore could be metal or plastic strips, or any other suitable materials for holding biological specimens. Thus, the term “slide” may indicate any substrate with a microscope slide footprint.

In the presently preferred embodiment, there are shown two gaskets 3 in a gasket slide 4, and thus there are two gasket compartments 6. The baseplate apertures 24 and coverplate apertures 28 are aligned accordingly with these compartments 6. This, however, is not to be construed as a limitation, and if gasket slides having 4, 8 or more gasketed compartments are used, it is to be understood that the baseplates and coverplates of the modules could be adapted to include corresponding numbers of apertures which align with these gasketed compartments.

FIG. 3 shows a view of a portion of FIG. 2 in more detail. Referring again generally to FIGS. 1-3, the frame 22 of the baseplate 12 is configured with recesses 18, which hold the slide assemblies in position. The recesses 18 are preferably formed with cut-out areas 32 which separate posts 34. A contact plane 36 is the area in which the frame 26 of the coverplate 14 will contact the frame 22 of the baseplate 12. This contact plane 36 preferably include screw holes 38 into which the fasteners 16 are engaged. The recesses 18 into which the slide assemblies 1 fit are configured at a depth dimension 42 greater than that of the contact plane 36, and include shelves 40 which surround the apertures 24. The depth 42 of the shelves 40 below the contact plane 36 is carefully configured to be slightly less than the thickness of the completed slide assembly 1 with the gaskets 3 uncompressed. When the coverplate 14 is fitted onto the baseplate 12, the frame 26 of the coverplate 14 first contacts the microscope slides 5. As the fasteners 16 are tightened, the gaskets 3 of the gasket slides 4, which are somewhat elastic, are compressed slightly until the contact plane 36 of the baseplate 12 prevents further travel of the coverplate 14, and the maximum compression of the gaskets 3 have been reached.

It will be appreciated that the pressure applied to the slide assemblies 1 by the module 10 is critical to the proper operation of the system. Too little pressure will allow sample material to leak out from the slide assemblies 1, and too much pressure will cause the slide assemblies 1 to crack. Thus, the configuration of the recesses 18 of the modules 10, including the depth dimension 42 of the shelves 40 is important.

It is additionally preferred that the cut-outs 32 have a depth dimension 44 which is yet deeper than the shelf depth dimension 42, compared to the contact plane 36 (see FIG. 3). This allows air-passages 46 to form between the edges of the lower slides 2 (which rest on the shelves 40) and the cut-outs 32. These air passages 46 allow for movement of heated air, and provide enhanced convection heating in further processing stages, as will be discussed below.

Referring now particularly to FIG. 1, the posts 34 are preferably configured to closely surround portions of the coverplate 14, which aids in the correct alignment of the fasteners 16 with the screw holes 38 and the coverplate apertures 28 with the gasketed compartments of the slide assemblies 1.

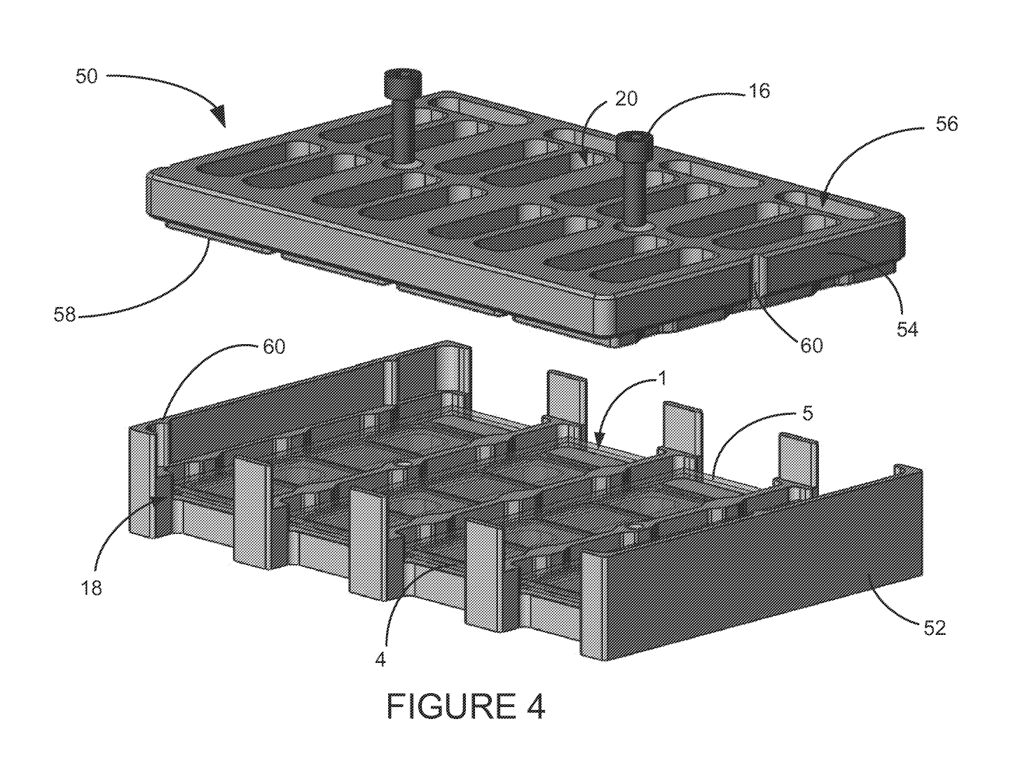

FIGS. 4-6 show an alternate embodiment of the microscope slide module, which will be referred to by the reference number 50. Where features of the alternate embodiment are similar to those in the first embodiment, the same reference numbers may be used, and the figures will be referred to generally in the following discussion.

FIG. 4 shows an isometric view of the modified microscope slide module 50, where the modified coverplate 54 has been elevated above the modified baseplate 52. As before, the module 50 is configured to hold from one to four slide assemblies 1 within recesses 18. The number of apertures 20 has been increased in both the baseplate 52 and coverplate 54 so that there are four apertures 20 per slide assembly 1. Additionally, a viewing aperture 56 has been added in both the baseplate 52 and coverplate 54 for each slide assembly 1, which allows viewing and/or scanning of bar-code information which may be included in the slide assembly 1.

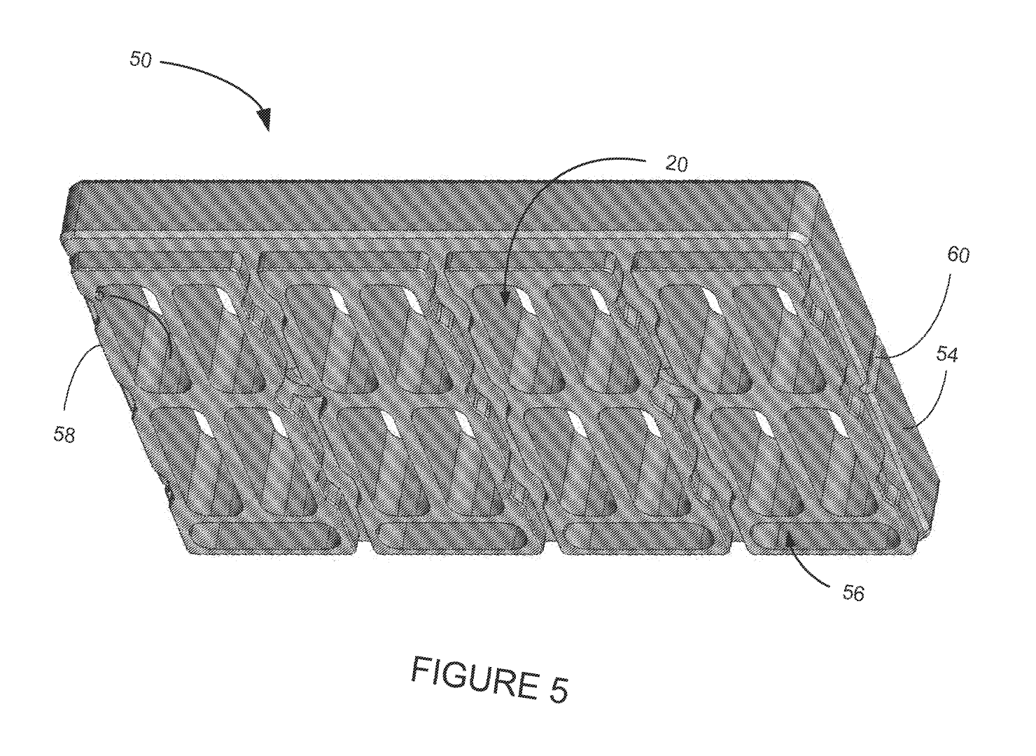

As particularly seen in FIG. 5, which is an isometric underside view of the coverplate 54, protruding areas or bosses 58 have been added, which aid in compressing the slide assembly 1, thus helping the upper microscope slide 5 to maintain a good seal with the gasket slide 4. Additionally, the bosses 58 allow for deeper recesses 18 in baseplate 52. This allows easier placement of microscope slides 5.

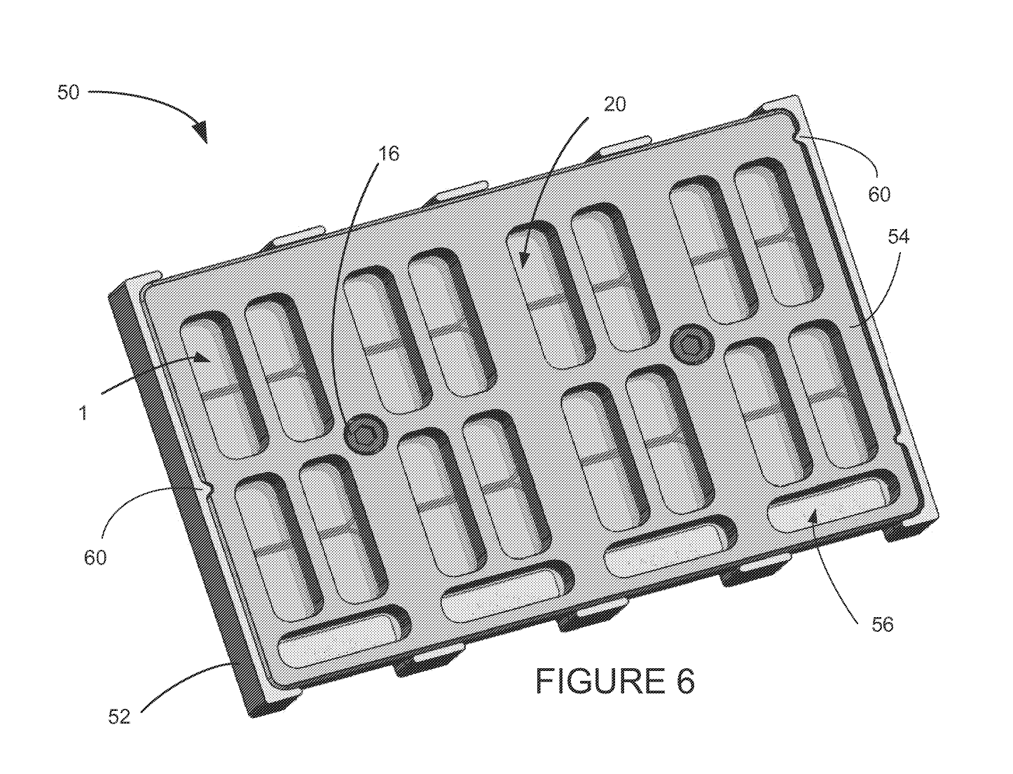

FIG. 6 shows a top isometric view of an assembled microscope slide module 50, from which it can be seen that two fasteners 16 are preferably used, although the type and number of fasteners is not to be taken as a limitation. Also alignment notches 60 have been included in the baseplate 52 and coverplate 54 to aid in the proper alignment of the components of the module 50.

Other variations of this invention may include designs that allow the aforementioned assemblies of microplate dimensions to be attached along the length, breadth or height of the first assembly to accommodate additional microscope slide/gasket assemblies in multiples of 4.

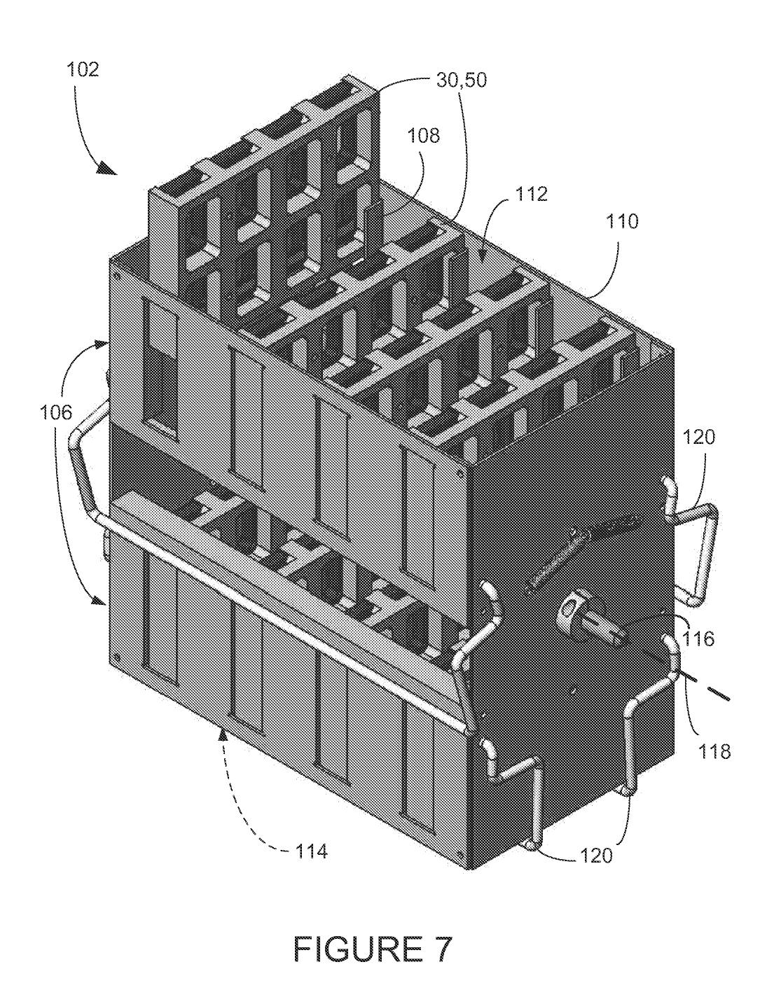

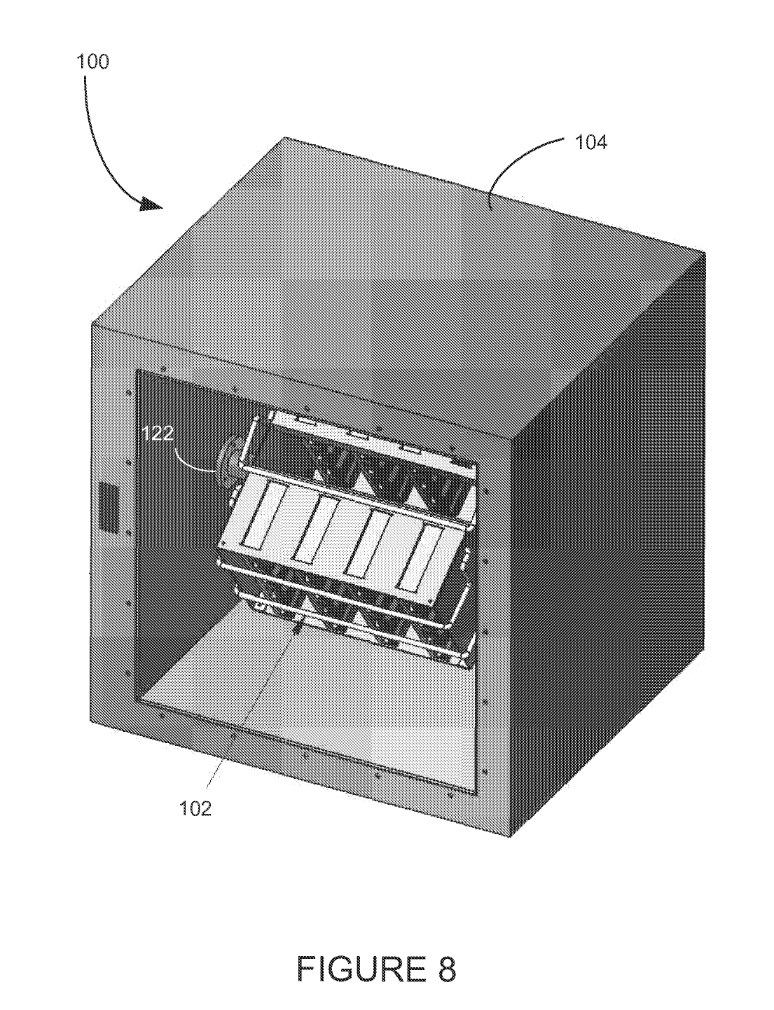

Referring now also to FIGS. 7 and 8, which show more of the sample processing system 100, after loading and sealing the microscope slide module 30, 50, the sealed microscope slide module 30, 50 is removed from the liquid handler (not shown) and inserted into a removable rotator 102 for a rotating oven 104 (FIG. 8) such as that sold by SciGene (Series 700 Microscope slide Oven). The design of the rotator 102 is such that the slide assemblies 1 in the module(s) 30, 50 are oriented in the centrifugal field so that the air bubble 8 in the samples 7 held in the gasket compartments 6 (FIG. 1) will move within the perimeter of the gasket 3 effecting mixing of the sample 7. After the samples 7 are incubated, typically overnight, the module(s) 30, 50 are removed from the rotator 102 and the coverplate 14 removed. The microscope slides 5 are then separated from the gasket slides 4 and then washed and dried using processors such as the SciGene Little Dipper Microscope slide Processor or by manual processing.

FIG. 7 shows a microscope slide module 30, 50 partially inserted into position on the rotator 102. The rotator 102 can be subject to considerable variation, but the embodiment shown includes two banks 106 of slots 108, which are configured to receive the microscope slide modules 30. The rotator 102 itself includes an enclosure 110, with a first opening 112 and a second opening 114 through which the microscope slide modules 30 are inserted into the slots 108. The rotator 102 also includes a spindle 116 which acts as the axis of rotation 118 for the rotator 102. Also included are a number of spring loaded retaining bars 120, which hold the microscope slide modules 30, 50 in place while rotating.

As stated before, in this depiction, the rotator 102 can hold eight microscope slide modules 30, 50, each holding up to four slide assemblies 1 of two gasketed compartments 6 each, but this should not be construed as a limitation. Rotators 102 with capacity for more or fewer microscope slide modules can be implemented, and all are contemplated by the present invention.

Referring now particularly to FIG. 8, once the rotator 102 has been loaded with the microscope slide modules 30, 50, and retaining bars 120 engaged, the rotator 102 is placed within the rotating oven 104 with rotator spindle 116 (FIG. 7) engaged with the oven's drive mechanism 122. The rotator 102 is then rotated at elevated temperature, thus allowing the air bubble 8 (FIG. 1) to mix the sample 7 while it is heated, as described above.

As it is the trend in the industry to use more and more automation in the processing of sample materials, it is desirable that the microscope slide module can be utilized by either manual manipulation, or by automated means. Thus, it is possible that the gasket slides may be placed into the baseplates, the sample materials loaded into the gasketed compartments, the microscope slides placed onto the gasket slides, the coverplate placed and fastened down by hand. Alternatively, there may be various automated devices which may pick and place these elements to assemble the modules, and then load and unload the modules into the ovens, and possibly perform further processing steps. The present module is easily adapted to such automated processing, and all such variations are contemplated by the present invention.

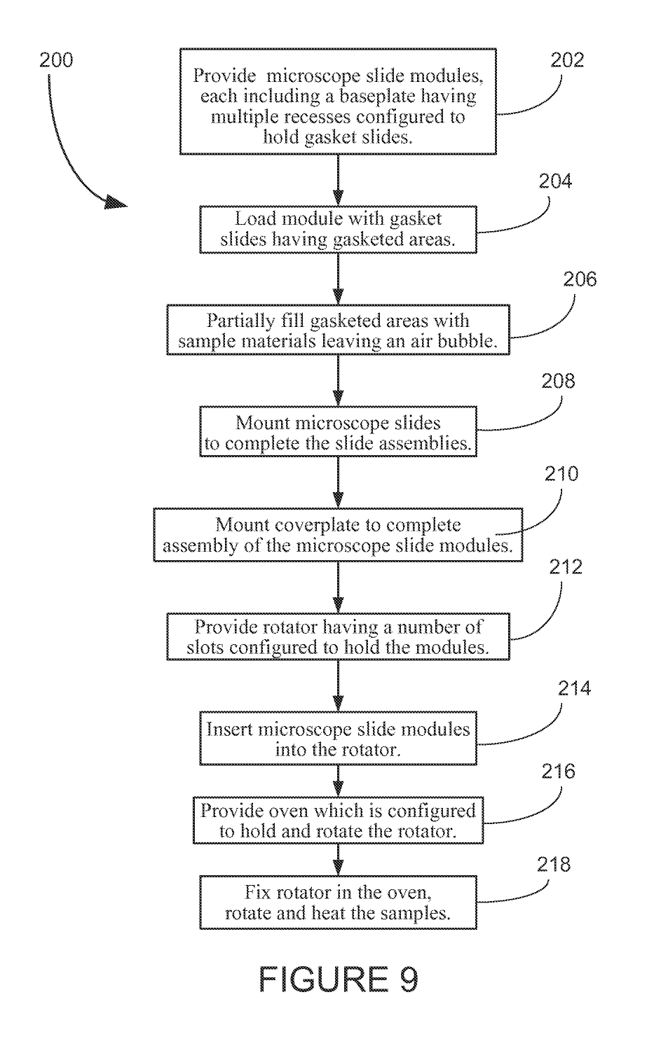

FIG. 9 shows a flow chart which illustrates the major stages in a preferred method 200 for processing of laboratory samples. A number of microscope slide modules, each including a baseplate having multiple recesses configured to hold gasket slides is provided 202, which is then loaded with gasket slides 204. The gasketed areas of the gasketed slides are partially filled with sample materials 206, and microscope slides are mounted 208 to complete the slide assemblies. A coverplate is on mounted 210 to complete the assembly of the microscope slide module. A rotator is provided having a number of slots configured to hold the modules 212. The microscope slide modules are inserted into the rotator 214. An oven is provided which is configured to hold and rotate the rotator 216. The rotator is then fixed in the oven, and the samples are rotated and heated 218.

It will be understood that the stages may be undertaken in alternative order, so that, for example, the microscope slide modules, rotator and oven may be provided together. Such variations will be obvious to one skilled in the art, and all are contemplated by the present invention.

While various embodiments have been described above, it should be understood that they have been presented by way of example only, and not limitation.

1-20. (canceled)

21. A microscope slide module for processing a sample captured in a gasketed compartment of a slide assembly comprising a gasket slide and a microscope slide, said microscope slide module comprising:
a baseplate comprising:
a baseplate frame;
a plurality of recesses, each recess configured to hold a slide assembly in fixed position;
a plurality of baseplate apertures; and
one or more screw holes; and
a coverplate comprising:
a coverplate frame;
a plurality of coverplate apertures that align with the baseplate apertures;
one or more fasteners capable of engaging the screw holes of the baseplate, such that slide assemblies are captured and slightly compressed between said baseplate and said coverplate.

22. The microscope slide module of claim 21, wherein the baseplate has four recesses.

23. The microscope slide module of claim 21, wherein the baseplate has two screw holes and the coverplate has two fasteners.

24. The microscope slide module of claim 21, wherein the coverplate further comprises a viewing aperture.

25. The microscope slide module of claim 21, wherein the coverplate further comprises a boss corresponding to each recess, said boss configured to aid in compressing the slide assembly.

26. The microscope slide module of claim 21, wherein said coverplate and said baseplate further comprise alignment notches.

27. The microscope slide module of claim 21, wherein said baseplate is of industry standard microplate footprint dimensions.

28. The microscope slide module of claim 21, wherein the coverplate frame contacts the baseplate frame at a contact plane.

29. The microscope module of claim 28, wherein the contact plane includes the screw holes of the baseplate.

30. A microscope slide module for processing a sample captured in a gasketed compartment of a slide assembly comprising a gasket slide and a microscope slide, said microscope slide module consisting of a baseplate and a coverplate,
said baseplate comprising:
a baseplate frame;
a plurality of recesses, each recess configured to hold a slide assembly in fixed position;
a plurality of baseplate apertures; and
one or more screw holes; and
said coverplate comprising:
a coverplate frame;
a plurality of coverplate apertures that align with the baseplate apertures;
one or more fasteners capable of engaging the screw holes of the baseplate, such that slide assemblies are captured and slightly compressed between said baseplate and said coverplate.

31. The microscope slide module of claim 30, wherein the baseplate has four recesses.

32. The microscope slide module of claim 30, wherein the baseplate has two screw holes and the coverplate has two fasteners.

33. The microscope slide module of claim 30, wherein the coverplate further comprises a viewing aperture.

34. The microscope slide module of claim 30, wherein the coverplate further comprises a boss corresponding to each recess, said boss configured to aid in compressing the slide assembly.

35. The microscope slide module of claim 30, wherein said coverplate and said baseplate further comprise alignment notches.

36. The microscope slide module of claim 30, wherein said baseplate is of industry standard microplate footprint dimensions.

37. The microscope slide module of claim 30, wherein the coverplate frame contacts the baseplate frame at a contact plane.

38. The microscope module of claim 37, wherein the contact plane includes the screw holes of the baseplate.
